(19) United States
(12) Patent Application Publication
(10) Pub. No.: US 2020/0061896 A1
(43) Pub. Date: Feb. 27, 2020

(54) Induction Heated Extrusion Melter

(71) Applicant: Khan Khac Tran, San Jose, CA (US)

(72) Inventor: Khan Khac Tran, San Jose, CA (US)

(21) Appl. No.: 16/112,727

(22) Filed: Aug. 26, 2018

(51) Int. Cl. B29C 47/86; B21C 29/04; B29C 64/295

(52) U.S. Cl. CPC B29C 47/862; B29C 2035/0811; B29C 64/295; B21C 29/04

(57) ABSTRACT

The Induction Heated Extrusion Melter is an invention for melting plastic and metal in an extrusion process. It is a component and is to be integrated into an apparatus. The operating temperature of the Induction Heated Extrusion Melter is in excess of two thousand degrees Fahrenheit. Therefore, it can melt many types thermoplastics and metals. The Induction Heated Extrusion Melter could melt metals such as, but not limited to, aluminum, brass or lead and plastics of various shapes and sizes. It could be used in additive manufacturing machines, where shapes are made by adding layers of molten material. It could also be used as part of an extrusion apparatus that extrude long continuous shapes.

### BACKGROUND

Additive Manufacturing Three Dimensional (3D) printers has become a popular technology to bring ideas into reality in a rapid manner. The 3D printer produces shapes by extruding melted plastic in a continuous layer and applying those layers on top of the other. A limitation of 3D printers is that can only extrude plastic, thus it can only produce plastic shapes. The maximum extruder temperature is around six hundred degrees Fahrenheit. This limitation is the main motivation for the development a higher temperature extruder that can melt both plastic and metal. Induction Heated Extrusion Melter was development to overcome previous limitations. Although the Induction Heated Extrusion Melter was developed for 3D printers, it can be integrated into many different types of machines that requires a high temperature extrusion of plastic or metal.

Inductive heating in extrusion equipment is generally know and this invention relates to U.S. Pat. Nos. 3,129,459 and 3,521,325. In U.S. Pat. No. 3,129,459 the extruder screw and the cylinder are inductively heated and can only melt plastic. The heated plastic then travels through the cylinder by the extruder screw. In U.S. Pat. No. 3,521,325 the die is heated and the extruded thermoplastic is shaped by the die. Whereas the Induction Heated Extrusion Melter can melt plastics and metals. The plastic or metals are fed into the heat chamber by an external force. Then the heated plastic or metal is extruded out the opposite end.

### DEFINITIONS

Electrical conductor coil (“coil”) is an electrically conductive solid or stranded wire, solid or hollow bar or tubing made into a helical coil shape. Hollow tubing is recommended for high temperature applications because coolant can circulate through the hollow tubing. The number of coil windings and the conductor size will be dependent on the application. The coil could be powered by either alternating current or direct current.

Feedstock are materials that are plastics or metals in the form of wires, solid bars, tubing, pellets or powders.

Heat chamber is the ferrous metal chamber that reacts to the electromagnetic flux of the energized coil and heats and melts the feedstock. The heat chamber would be of various shape for the desired extruded shape.

Entry chamber is a non-conductive chamber where the feedstock enters and passes through to the heat chamber.

Insulation is the material that insulate thermal transfer and/or electrical current. Insulation could be made of ceramic, cement or nonferrous and nonconducting metal.

Open-coil is the electrical conductor coil without a covering.

### REFERENCE NUMERALS

1—heat chamber

2—entry chamber

3—inner insulation

4—coil

5—outer insulation

6—open-coil melter

7—encased melter

### DESCRIPTION

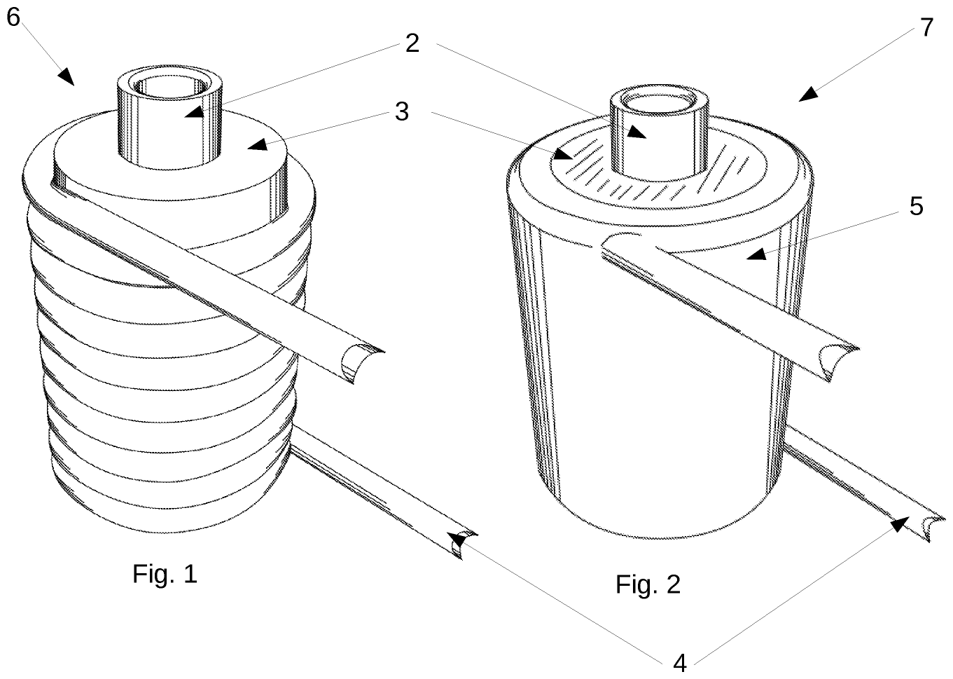

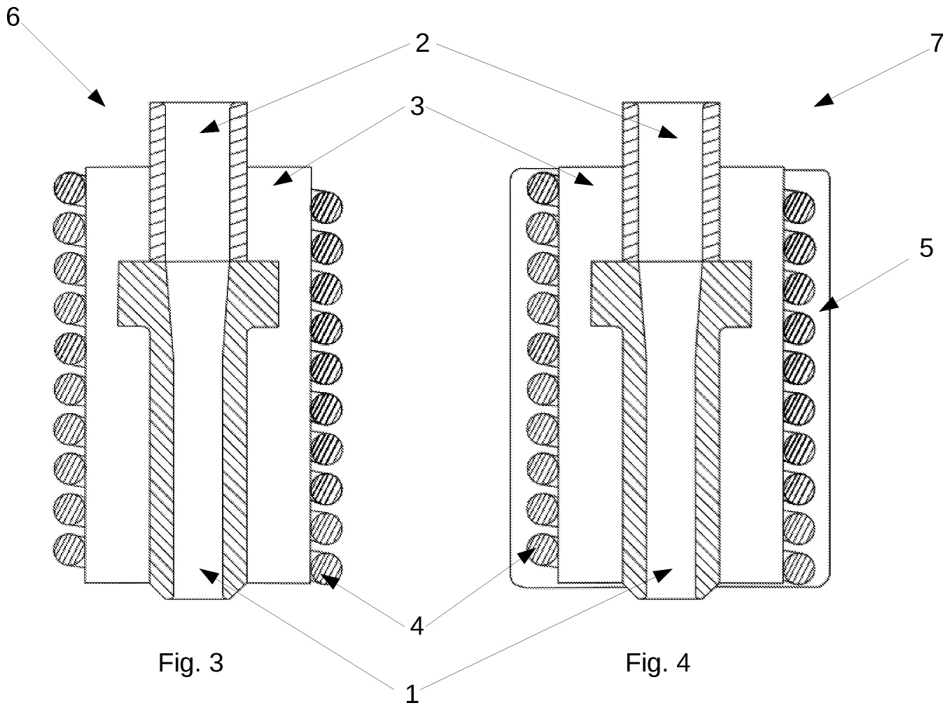

FIG. 1 is an elevated perspective view of the open coil melter 6. The entry point for feedstock is the input tube 2. The heat chamber 1 and entry chamber 2 (reference FIG. 3) are encased in the inner insulation 3. The coil 4 wraps around the inner insulation.

FIG. 2 is an elevated perspective view of the insulation encased melter 7. The entry point for feedstock is the entry chamber 2. The heat chamber 1 and entry chamber 2 (reference FIG. 4) are encased in the inner insulation 3. The coil 4 wraps around the inner insulation 3. The assembly is encased inside the outer insulation 5. The encased melter 7 is the open-coil melter 6 with an outer insulation 5.

FIG. 3 is a cutaway mid-section view of the open-coil melter 6. The inner most components are the heat chamber 1 and entry chamber 2. Feedstock enters through the entry chamber, passes into the heat chamber 1 and exits out the opposite end of heat chamber 1. The heat chamber 1 and entry chamber 2 are encased in the inner insulation 3. Then the coil 4 wraps around the inner insulation 3.

FIG. 4 is a cutaway mid-section view of the encased melter 7. The inner most components are the heat chamber 1 and entry chamber 2. Feedstock enters through the entry chamber 2, passes into the heat chamber 1 and exits out the opposite end of heat chamber 1. The heat chamber 1 and entry chamber 2 are encased in the inner insulation 3. Then the coil 4 wraps around the inner insulation 3. The assembly is then encased inside the outer insulation 5.

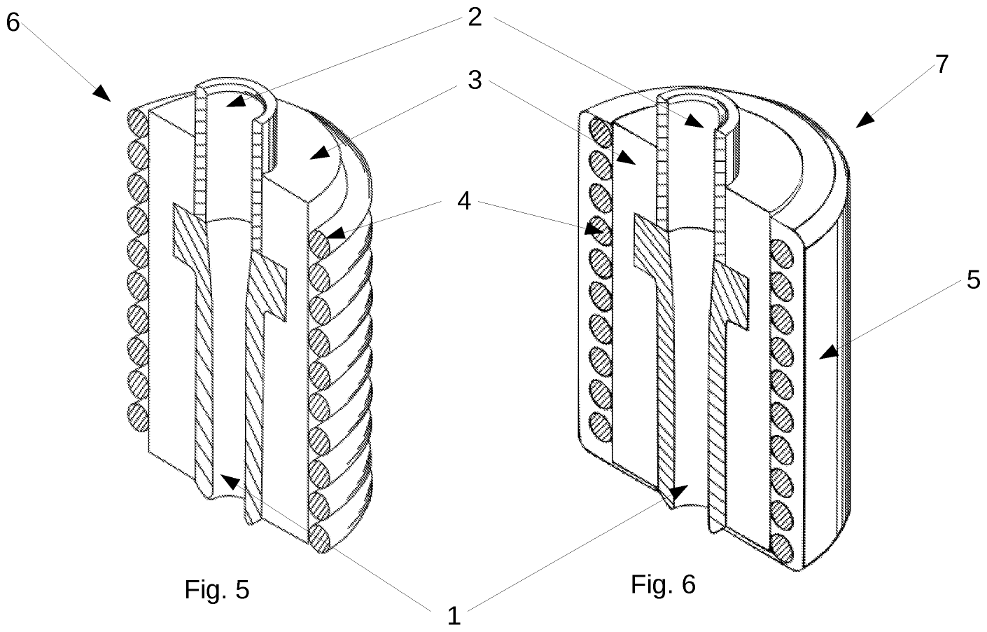

FIG. 5 is a cutaway mid-section axonometric view of the open-coil melter 6. The inner most components are the heat chamber 1 and entry chamber 2. The heat chamber 1 and entry chamber 2 are encased in the inner insulation 3. Then the coil 4 wraps around the inner insulation 3.

FIG. 6 is a cutaway mid-section axonometric view of the encased melter 7. The inner most components are the heat chamber 1 and entry chamber 2. The heat chamber 1 and entry chamber 2 are encased in the inner insulation 3. Then the coil 4 wraps around the inner insulation 3. The assembly is then encased inside the outer insulation 5.

### OPERATION

In operation, the open-coil melter 6 and encased melter 7 are the same. The only difference is how each are integrated and mounted into various apparatus. When describing the operation, it will apply to both the open-coil melter 6 and encased melter 7.

(1) The coil 4 will be connected to a regulated power source. In high temperature applications, a hollow coil is recommended and it will also be connected to a circulating liquid cooling system.

(2) When the coil 4 is powered and energized, it creates an electromagnetic field. The heat chamber 1 reacts to the electromagnetic field and increase temperature. Depending on the electrical current, electrical frequency and the material composition of the heat chamber 1, this will affect the temperature of the heat chamber 1.

(3) When the heat chamber 1 is above the melting temperature of the feedstock, the feed stock will enter the heat chamber 1 from the entry chamber 2. The feed rate will depend on the feed force and the feedstock physical properties.

(4) After the feedstock has reach the melting temperature and desired viscosity, it is forced out by the incoming feedstock. The rate of the extrusion is based on the feed rate and physical properties of the feedstock.

1. The Induction Heated Extrusion Melter is an invention that is used to extrude melted plastics or metals. It uses an external regulated electric current to induce an electromagnetic field in a conductive coil to inductively heat a ferrous metal chamber that is partially encased in insulation. The temperature of the chamber has the potential to reach in excess of two thousand degrees Fahrenheit. Which is hot enough melt all know plastics and some metals. Plastic or metal is fed into one end and is melted in the heated ferrous metal chamber. The feeding action from the incoming plastic or metal will force the melted plastic or metal to extrude out the opposite end.
